(19) United States
(12) Patent Application Publication
(10) Pub. No.: US 2010/0006244 A1
(43) Pub. Date: Jan. 14, 2010

(54) DEINKING A CELLULOSIC SUBSTRATE USING AN INORGANIC MINERAL

(76) Inventors: Prasad Y. Duggirala, Naperville, IL (US); Michael J. Murcia, DeKalb, IL (US)

Correspondence Address: Peter A. DiMattia;Patent and Licensing Department, Nalco Company, 1601 West Diehl Road, Naperville, IL, 60563-1198, US

(21) Appl. No.: 12/169,985

(22) Filed: Jul. 9, 2008

(51) Int. Cl. D21C 5/02; C11D 3/02

(52) U.S. Cl. 162/5; 162/4; 510/174

(57) ABSTRACT

A composition and method for deinking is disclosed. The composition and method contain an activated inorganic mineral.

### FIELD OF THE INVENTION

The invention pertains to compositions and methods for deinking a cellulosic substrate.

### BACKGROUND OF THE INVENTION

Efficiently removing ink from secondary fiber without impacting fiber quality is one of the major challenges in paper recycling. Currently, the most widespread method of removing ink from secondary fiber is an alkaline process that uses sodium hydroxide, sodium silicate, hydrogen peroxide, surfactants and chelants. The caustic is used to elevate the pH in the repulper causing the fiber to swell, which assists in ink detachment, but also yellows the fiber due to interaction with lignin in mechanical grades, resulting in a brightness loss. Peroxide is added to reduce fiber yellowing, and chelant is added to prevent peroxide degradation by metals. Surfactants are used to manage the detached ink and prevent redeposition onto the fiber.

While the conventional method of deinking is effective for ink removal, it has disadvantages. When the cost of the chemicals needed to overcome the unwanted effects of caustic is considered, the alkaline method is quite expensive. Aside from the high cost of the chemicals used, handling caustic can be hazardous, and it is critical to maintain the proper balance of caustic, peroxide and silicate to produce fiber with the desired optical properties. Moreover, any residual fiber yellowing, or chromophoric generation, that is caused by caustic and cannot be removed with bleaching is balanced blue dye to the fiber. While this is effective for achieving a neutral color balance, it reduces ISO brightness, making it difficult to reach brightness targets. In addition, a recent study showed that fiber strength and tensile index was reduced for secondary fiber deinked under alkaline conditions. Finally, the elevated pH in the pulper saponifies adhesives, thereby introducing more stickies into the papermaking system, which cause runnability problems for the paper machine.

An improved methodology is therefore desired.

### SUMMARY OF THE INVENTION

The present invention provides for composition comprising: (a) an activated inorganic mineral; (b) a suspending agent for said activated inorganic mineral; (c) water; (d) an emulsifier; (e) optionally excluding caustic soda; and (f) optionally excluding hydrogen peroxide.

The present invention also provides for a method of removing ink from a cellulosic containing substance comprising: (a) adding to the substance a composition comprising: (1) activated inorganic mineral, (2) xanthan gum, (3) tall oil fatty acid, (4) sodium lauryl sulfate, and (5) water; (b) optionally excluding the addition of caustic soda to the cellulosic containing substance; and (c) optionally excluding the addition of hydrogen peroxide to the cellulosic containing substance.

### DETAILED DESCRIPTION OF THE INVENTION

### A. Definitions

“Suspending agent” means one or more agents that prevents precipitation of a stabilized dispersion of colloidal particles in solution.

“Activated inorganic mineral” means a formulation that includes an inorganic mineral plus one or more components that provides additional deinking performance over the inorganic mineral alone, e.g. oil added as formulation with inorganic mineral. For example, if the inorganic mineral is mixed with an oil and that oil meets the requirements of providing additional deinking performance, then the inorganic mineral is an activated inorganic mineral.

“Recycling process” means any process that involves the handling of secondary fibers.

“TOFA” means tall oil fatty acid.

“%” means percent by weight of the composition.

### B. Compositions

As stated above, the disclosure provides for a composition comprising: (a) an activated inorganic mineral; (b) optionally a suspending agent for said activated inorganic mineral; (c) water; (d) an emulsifier, (e) optionally excluding caustic soda; and (f) optionally excluding hydrogen peroxide.

In one embodiment, the suspending agent is a thickening agent.

In another embodiment, the thickening agent is selected from the group consisting of: galactomannans; guar gum; locust bean gum; xanthan gum; para gum; cellulosics; hydroxypropyl methylcellulose; hydroxypropyl cellulose; carrageean; alginates; sodium alginates; potassium alginates; ammonium salt alginates; and a combination thereof.

In another embodiment, the composition contains from about 5% to about 70% of said activated inorganic mineral, based upon weight of the composition.

In another embodiment, the composition contains about 18% to about 47% of said activated inorganic mineral, based upon weight of the composition.

In another embodiment, the composition contains from about 0.05% to about 20% of said suspending agent, based upon weight of the composition.

In another embodiment, the composition contains about 0.3% to about 0.4% of said suspending agent, based upon weight of the composition.

In another embodiment, the composition comprises an oil.

In another embodiment, the composition contains from about 2% to about 55% of said oil based upon the weight of the composition.

In another embodiment, the composition contains from about 22% to about 30% of said oil based upon the weight of the composition.

In another embodiment, the oil contains a fatty acid.

In another embodiment, the oil is used to form an oil and water emulsion.

In another embodiment, the composition contains from about 0.5% to about 20% of said emulsifier.

In another embodiment, the composition contains from about 2% to about 3% of said emulsifier.

In another embodiment, the emulsifier is a surfactant.

In another embodiment, the fatty acid contains a tall oil fatty acid.

In another embodiment, the emulsifier is selected from the group consisting of: sorbitol derivatives; polysorbate 80; sorbitan monolaurate; polysorbate 20; ethoxylated alcohols; sodium laureth sulfate; polyethylene glycol; sulfate esters; sodium lauryl sulfate; and a combination thereof.

In another embodiment, the composition comprises: (a) activated inorganic mineral; (b) xanthan gum; (c) tall oil fatty acid; (d) sodium lauryl sulfate; and (e) water.

In farther embodiment, the composition is comprised of about 18% to about 47% of said activated inorganic mineral; about 0.3% to about 0.4% xanthan gum; about 22% to about 30% tall oil fatty acid; and about 2% to about 3% sodium lauryl sulfate.

In another embodiment, the composition excludes caustic soda, optionally comprising rosin wherein the content of rosin in the composition is from greater than 0% to about 30% based upon weight of the fatty acid.

These compositions may be applied in methods of removing ink from a cellulosic containing substance/substrate. In the next section, various embodiments of these applications are discussed.

### C. Methods

As stated above, the disclosure provides for a method of removing ink from a cellulosic containing substance comprising: (a) adding to the substance a composition comprising: (1) activated inorganic mineral, (2) xanthan gum, (3) tall oil fatty acid, (4) sodium lauryl sulfate, and (5) water; (b) optionally excluding the addition of caustic soda to the cellulosic containing substance; and (c) optionally excluding the addition of hydrogen peroxide to the cellulosic containing substance.

The performance of a deinking process can be measured in a variety of ways. Typically, optical properties such as brightness (B), whiteness (L), red/green color balance (a) and yellow/blue color balance (b*) are measured on a sheet formed from the resulting deinked fiber. In addition to optical properties, an ink speck count measurement is used to evaluate the efficiency with which the ink is removed. Residual ink can be expressed in terms of specks/unit area, percent coverage of ink specks on an area, or effective residual ink concentration (ERIC), which is commonly expressed in ppm.

In one embodiment, the cellulosic substance is located anywhere in a recycling process up through one or more flotation accepts.

In another embodiment, the emulsifier is added separately to the cellulosic containing substance.

In another embodiment, the suspending agent is a thickening agent.

In another embodiment, the thickening agent is selected from the group consisting of: galactomannans; guar gum; locust bean gum; xanthan gum; para gum; cellulosics; hydroxypropyl methylcellulose; hydroxypropyl cellulose; carrageean; alginates; sodium alginates; potassium alginates; ammonium salt alginates; and a combination thereof.

In another embodiment, the composition contains from about 5% to about 70% of said activated inorganic mineral, based upon weight of the composition.

In another embodiment, the composition contains about 18% to about 47% of said activated inorganic mineral, based upon weight of the composition.

In another embodiment, the composition contains from about 0.05% to about 20% of said suspending agent, based upon weight of the composition.

In another embodiment, the composition contains from about 0.3% to about 0.4% of said suspending agent, based upon weight of the composition.

In another embodiment, the composition further comprises: an oil.

In another embodiment, the composition contains from about 2% to about 55% of said oil based upon the weight of the composition.

In another embodiment, the composition contains from about 22% to about 30% of said oil based upon the weight of the composition.

In another embodiment, the composition contains from about 0.5% to about 20% of said emulsifier.

In another embodiment, the composition contains from about 2% to about 3% of said emulsifier.

In another embodiment, the oil contains a fatty acid.

In another embodiment, the oil is used to form an oil and water emulsion.

In another embodiment, the emulsifier is a surfactant.

In another embodiment, the fatty acid contains a tall oil fatty acid.

In another embodiment, the emulsifier is selected from the group consisting of: sorbitol derivatives; polysorbate 80; sorbitan monolaurate; polysorbate 20; ethoxylated alcohols; sodium laureth sulfate;polyethylene glycol; sulfate esters; sodium lauryl sulfate; and a combination thereof.

In another embodiment, the composition excludes caustic soda.

In another embodiment, the composition further comprises rosin, optionally wherein the content of rosin in the composition is from greater than 0% to about 30% based upon weight of the fatty acid.

In another embodiment, the method of removing ink from a cellulosic containing substance comprises: (a) adding to the substance a composition comprising: (1) an activated inorganic mineral, (2) a xanthan gum, (3) a tall oil fatty acid, (4) a sodium lauryl sulfate, and (5) water; (b) optionally excluding the addition of caustic soda to the cellulosic containing substance; and (c) optionally excluding the addition of hydrogen peroxide to the cellulosic containing substance.

In a further embodiment, the composition is comprised of about 18% to about 47% of said activated inorganic mineral; about 0.3% to about 0.4% xanthan gum; about 22% to about 30% tall oil fatty acid; and about 2% to about 3% sodium lauryl sulfate.

The methodologies of the present invention can be applied to a paper recycling process, when deinking is desired.

In one embodiment, the composition is added to a paper recycling process in at least one of the following locations: a pulper; dilution stage; flotation cell thickening stage; and a kneader.

In another embodiment, the composition is added in a pulper of a paper recycling process.

In another embodiment, the composition is added at a dilution stage of a paper recycling process.

In another embodiment, the composition is added at a thickening stage of a paper recycling process.

In another embodiment, the composition is added in a flotation cell of a paper recycling process.

In another embodiment, the composition is added in a kneader of a paper recycling process.

In another embodiment, the substance contains one or more paper fibers.

In another embodiment, the paper fibers are secondary fibers in a paper recycling process.

We claim:

1. A composition comprising:
a. an activated inorganic mineral;
b. optionally including a suspending agent for said activated inorganic mineral;
c. water
d. an oil;
e. an emulsifier;
f. optionally excluding caustic soda; and
g. optionally excluding hydrogen peroxide.

2. The composition of claim 1, wherein said suspending agent is a thickening agent.

3. The composition of claim 2, wherein said thickening agent is selected from the group consisting of: galactomannans; guar gum; locust bean gum; xanthan gum; para gum; cellulosics; hydroxypropyl methylcellulose; hydroxypropyl cellulose; carrageean; alginates; sodium alginates; potassium alginates; ammonium salt alginates; and a combination thereof.

4. The composition of claim 1, wherein said composition contains from about 5% to about 70% of said activated inorganic mineral, based upon weight of the composition.

5. The composition of claim 1, wherein said composition contains from about 0.05% to about 20% of said suspending agent, based upon weight of the composition.

6. The composition of claim 1 wherein said composition contains from about 2% to about 55% of said oil based upon the weight of the composition.

7. The composition of claim I wherein said composition contains from about 0.5% to about 20% of said emulsifier.

8. The composition of claim 1, wherein said oil contains a fatty acid, optionally further comprising rosin, optionally wherein the content of rosin in the composition is from greater than 0% to about 30% based upon weight of the fatty acid.

9. The composition of claim 1, wherein said oil is used to form an oil and water emulsion.

10. The composition of claim 1 wherein said emulsifier is a surfactant.

11. The composition of claim 8, wherein said fatty acid contains a tall oil fatty acid.

12. The composition of claim 1, wherein the emulsifier is selected from the group consisting of: sorbitol derivatives; polysorbate 80; sorbitan monolaurate; polysorbate 20; ethoxylated alcohols; sodium laureth sulfate;polyethylene glycol; sulfate esters; sodium lauryl sulfate; and a combination thereof

13. A composition comprising:
a. activated inorganic mineral;
b. xanthan gum,
c. tall oil fatty acid,
d. sodium lauryl sulfate; and
e. water.

14. The composition of claim 13 wherein the composition comprises about 18 to about 47% of said activated inorganic mineral; about 0.3% to about 0.4% xanthan gum; about 22% to about 30% tall oil fatty acid; and about 2 to about 3% sodium lauryl sulfate.

15. A method of removing ink from a cellulosic containing substance comprising:
(a) adding to the substance a composition comprising: (1) activated inorganic mineral, (2) water, (3) optionally a suspending agent for said activated inorganic mineral, and (4) optionally an emulsifier;
(b) optionally excluding the addition of caustic soda to the cellulosic containing substance; and
(c) optionally excluding the addition of hydrogen peroxide to the cellulosic containing substance.

16. The method of claim 15, wherein said cellulosic substance is located anywhere in a recycling process up through one or more flotation accepts.

17. The method of claim 15, wherein the composition is added to a paper recycling process in at least one of the following locations: a pulper; dilution stage; flotation cell thickening stage; and a kneader

18. A method of removing ink from a cellulosic containing substance comprising:
(a) adding to the substance a composition comprising: (1) activated inorganic mineral, (2) xanthan gum, (3) tall oil fatty acid, (4) sodium lauryl sulfate, and (5) water;
(b) optionally excluding the addition of caustic soda to the cellulosic containing substance; and
(c) optionally excluding the addition of hydrogen peroxide to the cellulosic containing substance.

19. The method of claim 18 wherein the composition comprises about 18 to about 47% of said activated inorganic mineral; about 0.3% to about 0.4% xanthan gum; 0.395% xanthan gum; about 22% to about 30% tall oil fatty acid; and about 2% to about 3% sodium lauryl sulfate.
